(19) United States
(12) Patent Application Publication
(10) Pub. No.: US 2016/0140539 A1
(43) Pub. Date: May 19, 2016

(54) RELAY ATTACK DEFENSE SUPPORT SYSTEM

(71) Applicant: Empire Technology Development LLC, Wilmington, DE (US)

(72) Inventors: Xudong MA, Clifton Park, NY (US); Harm CRONIE, Poliez-le-Grand (CH)

(21) Appl. No.: 14/651,191

(22) PCT Filed: Nov. 18, 2014
(86) PCT No.: PCT/US14/66211

§ 371 Date: Jun. 10, 2015

(51) Int. Cl. G06Q 20/32; H04L 29/06

(52) U.S. Cl. CPC G06Q 20/3278; H04L 63/1416; G06Q 2220/00

(57) ABSTRACT

In some examples, a method to defend against relay attacks includes recording a first representation of a motion signal associated with a mobile device. The first representation of the motion signal is obtained by remotely sensing the motion of the mobile device. The method also includes receiving data indicative of a second representation of the motion signal associated with the mobile device. The second representation of the motion signal is obtained by sensing the motion of the mobile device in-situ. The method also includes comparing the first representation of the motion signal with the second representation of the motion signal and verifying, based on the results of the comparison, that a relay attack is not present when the first representation of the motion signal is substantially similar to the second representation of the motion signal.

### BACKGROUND

Unless otherwise indicated herein, the materials described herein are not prior art to the claims in the present application and are not admitted to be prior art by inclusion in this section.

Alternative payment systems that utilize smart phones, chip cards, radio-frequency identification (RFID) devices, and other wireless mobile devices are growing in popularity. However, such payment systems can also be vulnerable to security issues. For example, one security issue for wireless payment systems is the relay attack, or man-in-the-middle attack. In these types of attacks, the attacker acts as a “relay” between the two ends of the communication link during wireless payment transactions and intercepts payment information.

In one relay attack scenario, a customer approaches a first wireless point of sale terminal to purchase an item with his or her mobile device. However, unbeknownst to the customer, the first wireless point of sale terminal has been “hacked,” or “owned” by an attacker who is positioned at a second point of sale terminal and ready to purchase an item. The attacker at the second point of sale terminal may initiate a payment transaction with the second point of sale terminal, causing the second point of sale terminal to send a transaction start message to the attacker's mobile device. The attacker's mobile device can then relay the transaction start message to the first wireless point of sale terminal that has been hacked by the attacker. The first wireless point of sale terminal will then send the transaction start message to the consumer's mobile device. The consumer's mobile device will respond by sending sensitive payment information, such as a personal identification number (PIN) or password, to the first wireless point of sale terminal. The first wireless point of sale terminal then relays the sensitive payment information to the attacker's mobile device where the attacker can use this information to complete his transaction at the second wireless point of sale terminal. The attacker can also modify the payment transaction information according to his or her desires to purchase expensive items unbeknownst to the customer. Thus, the customer may believe he is paying for his item at the first wireless point of sale terminal, but in reality he is paying for the attacker's item at the second wireless point of sale terminal.

In another relay attack scenario the victim may not approach, or even know about the existence of a point of sale terminal. In this scenario, the attacker can carry a mobile point of sale terminal in his or her backpack and get close enough to the victim to initiate a payment transaction with the victim's mobile device. The attacker can then relay the victim's payment information to another point of sale terminal, as described above.

In another relay attack scenario a victim may be dining at a restaurant and wish to pay for his meal with his chip card, unaware that the restaurant is corrupt. When the victim asks the waiter for the bill, the waiter can send a text message to his accomplice who is waiting in a jeweler's store (or other business). The accomplice initiates a payment transaction for a diamond (or other merchandise) at the jeweler's store and relays the transaction start message to the waiter's point of sale terminal, which then sends the transaction start message to the victim's chip card. The victim's chip card responds by sending a PIN, password, digital signature, or other sensitive information to the waiter's point of sale terminal. The waiter's point of sale terminal then relays this information to the accomplice's mobile device where it can be used to complete the transaction for the diamond. Thus, the customer believes he is paying for his meal at the restaurant, but in fact he is buying a diamond for the attackers.

### SUMMARY

Technologies described herein generally relate to defending against relay attacks. In some examples, a method to defend against relay attacks includes recording a first representation of a motion signal associated with a mobile device. The first representation of the motion signal associated with the mobile device is obtained by remotely sensing the motion of the mobile device. The method also includes receiving data indicative of a second representation of the motion signal associated with the mobile device. The second representation of the motion signal associated with the mobile device is obtained by sensing the motion of the mobile device in-situ. The method also includes comparing the first representation of the motion signal associated with the mobile device with the second representation of the motion signal associated with the mobile device and verifying, based on the results of the comparison, that a relay attack is not present when the first representation of the motion signal associated with the mobile device is substantially similar to the second representation of the motion signal associated with the mobile device.

In some examples, a system to defend against relay attacks includes a remote sensor configured to remotely sense a first representation of a motion signal associated with a mobile device. The first representation of the motion signal can be recorded by a recorder module that is configured to be in electronic communication with the remote sensor. The system can also include a receiver configured to receive data indicative of a second representation of the motion signal associated with the mobile device. The second representation of the motion signal can be obtained by sensing the motion of the mobile device in-situ. The system may also include a motion analysis module configured to compare the first representation of the motion signal with the second representation of the motion signal and verify, based on the results of the comparison, that a relay attack is not present when the first representation of the motion signal associated with the mobile device is substantially similar to the second representation of the motion signal.

In some implementations, a non-transitory computer-readable medium includes computer-readable instructions stored thereon that are executable by a processor to perform or control performance of operations that include recording a first representation of a motion signal associated with a mobile device. The first representation of the motion signal associated with the mobile device is obtained by remotely sensing the motion of the mobile device. The operations also include receiving data indicative of a second representation of the motion signal associated with the mobile device. The second representation of the motion signal associated with the mobile device is obtained by sensing the motion of the mobile device in-situ. The operations also include comparing the first representation of the motion signal associated with the mobile device with the second representation of the motion signal associated with the mobile device and verifying, based on the results of the comparison, that a relay attack is not present when the first representation of the motion signal associated with the mobile device is substantially similar to the second representation of the motion signal associated with the mobile device.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings. In the drawings:

FIG. 1 is a block diagram of an example operating environment;

FIG. 2 is a block diagram illustrating an example relay attack defense support system;

FIG. 3 shows an example flow diagram of a method to defend against relay attacks;

FIG. 4A shows an example flow diagram of a method to associate payment transaction data with motion signal data at a mobile device;

FIG. 4B shows an example flow diagram of a method to encrypt data at a mobile device;

FIG. 5A shows an example flow diagram of a method to extract the associated data of FIG. 4A at a point of sale terminal;

FIG. 5B shows an example flow diagram of a method to decrypt the data of FIG. 4B at a point of sale terminal; and

FIG. 6 is a block diagram illustrating an example computing device 600 configured to detect relay attacks,

all arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. The aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to methods, apparatus, systems, devices, and computer program products that generally relate to defending against relay attacks based on simultaneously sensing the motion of a mobile device both in-situ and remotely, then comparing these two signals to each other to see how similar they are to each other. It is difficult for a relay attacker to watch a customer make a motion with his or her mobile device and then try and replicate the same motion. Thus, the methods, apparatus, systems, devices, and computer program products described herein make it difficult for a relay attacker to carry out relay attacks.

As an example, accelerometers and/or gyroscopes can be configured to sense the motion of a mobile device in-situ. The accelerometers and/or gyroscopes can be associated with the mobile device such that movement of the mobile device also causes the accelerometers and/or gyroscopes to follow the same movement as the mobile device. Electronic signals from the accelerometers and/or gyroscopes can be recorded and sent to a point of sale terminal with one or more remote sensors configured to sense and measure the motion of the mobile device from a remote position at the same time as the accelerometers and/or gyroscopes are measuring the motion of the mobile device in-situ. The two motion signals can then be compared to each other to see if they are substantially similar enough to each other.

As another example, an array of antennas can be used in conjunction with various wireless localization techniques in order to remotely sense the motion of the mobile device. The mobile device may transmit a wireless signal and the array of antennas can remotely locate the position of the mobile device in space based on the timing, angle, or power of the signals received by the array of antennas.

In a further example, one or more cameras can be used to remotely locate the position of the mobile device in space by capturing and processing images of the mobile device, or by measuring the time it takes light to travel to and from the mobile device, or by determining the position of the mobile device relative to a depth map of the scene surrounding the mobile device.

If the in-situ motion signal is not substantially similar to the remote motion signal, an alarm signal may be generated that indicates the presence of a relay attack and the electronic payment transaction may be aborted.

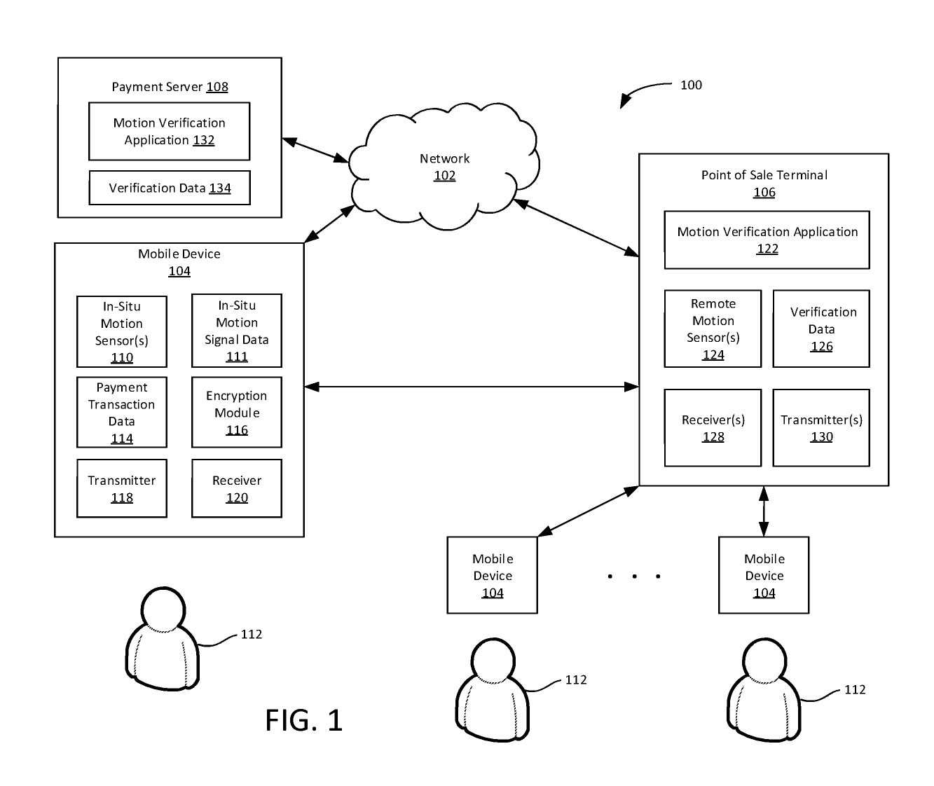

FIG. 1 is a block diagram of an example operating environment 100, arranged in accordance with at least some embodiments described herein. The operating environment 100 may include a network 102, one or more mobile devices (hereinafter “mobile device” or “mobile devices”) 104, a point of sale terminal 106, a payment server 108, and one or more customers (hereinafter “customer” or “customers”) 112. Each mobile device 104 may be associated with a corresponding one of the customers 112.

In general, the network 102 may include one or more wide area networks (WANs) and/or local area networks (LANs) that enable the mobile devices 104 and the point of sale terminal 106 to communicate with the payment server 108. In some implementations, the network 102 includes the Internet, including a global internetwork formed by logical and physical connections between multiple WANs and/or LANs. Alternately or additionally, the network 102 may include one or more cellular RF networks and/or one or more wired and/or wireless networks such as 802.xx networks, Bluetooth access points, wireless access points, IP-based networks, or the like. The network 102 may also include servers that enable one type of network to interface with another type of network.

Each of the mobile devices 104 may include a mobile phone, a smartphone, a chip card, a radio-frequency identification (RFID) device, a personal digital assistant (PDA), an e-reader device, a tablet computer, a laptop computer, a smart watch, a wearable device, or other suitable mobile device. The mobile devices 104 may be substantially free to move in space and generally configured to enter into electronic payment transactions with one or more point of sale terminals 106. In some implementations, electronic payment transactions between each mobile device 104 and point of sale terminal 106 may also be aided by one or more payment servers 108.

Each mobile device 104 may include one or more in-situ motion sensors (hereinafter “in-situ motion sensor” or “in-situ motion sensors”) 110, in-situ motion signal data 111, payment transaction data 114, an encryption module 116, a transmitter 118, and a receiver 120. It will be understood that the transmitters and receivers for the devices discussed herein may be combined into a single functional unit, such as a transceiver, or may be separated into different functional units. For simplicity, the in-situ motion sensor 110, in-situ motion signal data 111, payment transaction data 114, encryption module 116, transmitter 118, and receiver 120 are illustrated in FIG. 1 for a single one of the mobile devices 104, and each of the other mobile devices 104 may similarly include one or more of the foregoing components. Additionally, each mobile device 104 can include other components not shown, such as a processor device, memory, a display, input and output devices, and a communication interface.

The in-situ motion sensor 110 may generally be configured to sense the motion of the mobile device 104 as the customer 112 moves the mobile device 104 through space. The in-situ motion sensor 110 may generate a motion signal representative of the motion of the mobile device 104 as it moves through space. The in-situ motion sensor 110 may be integrally associated with the mobile device 104 such that the in-situ motion sensor 110 substantially follows the same motion of the mobile device 104 as the customer 112 moves the mobile device. For example, the in-situ motion sensor 110 may be an integral component of the mobile device 104.

The customer 112 can move the mobile device 104 in any direction in space, with any motion pattern, and with any speed. The in-situ motion sensor 110 can include one or more accelerometers that may be configured to sense acceleration and/or translational movement in one, two, or three axes. The in-situ motion sensor 110 can also include one or more gyroscopes that may be configured to sense rotational movement about one, two, or three axes. Similarly, the in-situ motion sensor 110 can include any sensor that allows the motion of the mobile device to be sensed as the customer moves the mobile device through space, including one or more of: cameras, light sensors, ultrasonic sensors, magnetic sensors, radio frequency sensors, or other suitable motion sensor. The in-situ motion sensor 110 can be configured to generate one or more electronic signals representative of the motion of the mobile device 104 as it moves through space. The mobile device can also be configured to capture and record these electronic signals in memory as in-situ motion signal data 111.

The mobile device 104 may also be configured to store payment transaction data 114. The payment transaction data 114 can include customer-specific authentication information such as a PIN, public and/or private digital signatures, public and/or private keys, as well as any other data that may be used to facilitate electronic payment transactions. The payment transaction data 114 can be used during electronic payment transactions to verify the identity of the customer 112 and/or verify the identity of the customer's mobile device 104. The payment transaction data 114 can be associated with the in-situ motion signal data 111 and sent to the point of sale terminal 106. For example, the payment transaction data 114 can be associated with the in-situ motion signal data 111 by appending the payment transaction data 114 to the beginning or end of the in-situ motion signal data 111, or by mixing the payment transaction data 114 anywhere within the in-situ motion signal data 111.

The encryption module 116 may generally be configured to encrypt data sent to the point of sale terminal 106, and/or the payment server 108, by the mobile device 104. Any suitable encryption method or technique can be used to help prevent unauthorized parties from deciphering communications between the devices shown in FIG. 1. The encryption module 116 can be configured to encrypt payment transaction data 114. The encryption module 116 can also be configured to encrypt the in-situ motion signal data 111 and/or any associated data comprising both payment transaction data 114 and in-situ motion signal data 111.

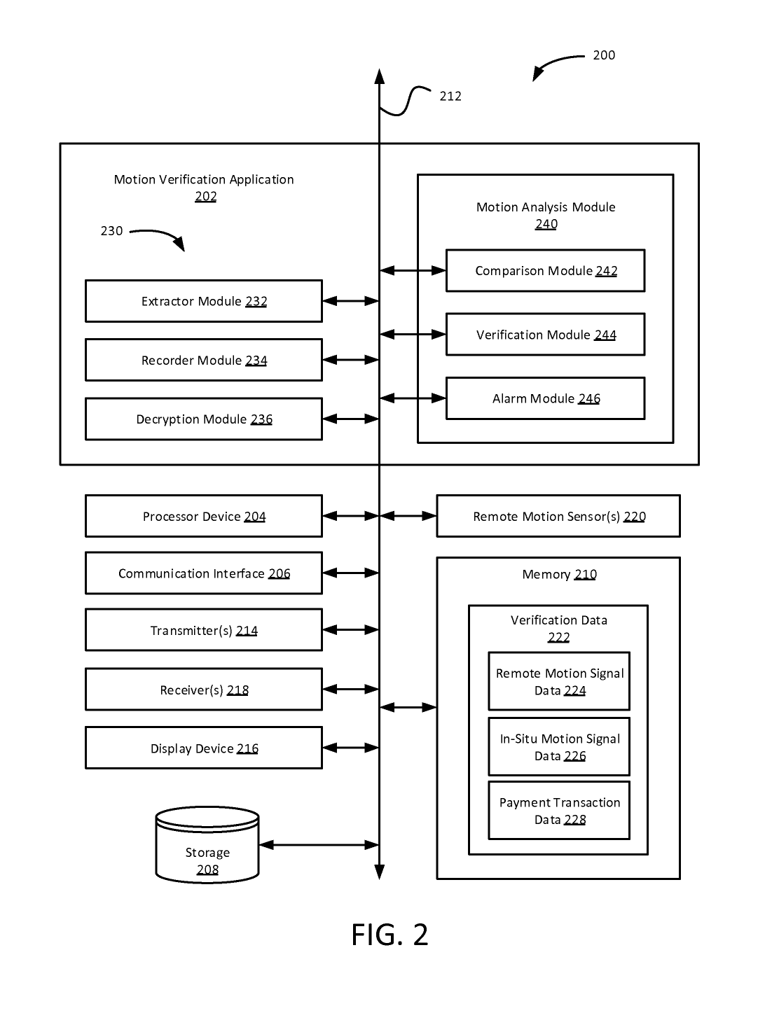

The point of sale terminal 106 may include a motion verification application 122, one or more remote motion sensors 124, verification data 126, one or more receivers 128, and one or more transmitters 130. The motion verification application 122 may be configured to detect and/or prevent relay attacks, as will be discussed in greater detail below with respect to FIG. 2.

Any of the transmitters 118, 130 and receivers 120, 128 shown in FIG. 1 or other figures can be configured to operate in a wired or wireless configuration to exchange data between the mobile device 104, the point of sale terminal 106, and/or the payment server 108. In wireless configurations, the transmitters 118, 130, 214 and receivers 120, 128, 218 can use one or more wireless communications methods, including: IEEE 802.11, IEEE 802.16, BLUETOOTH®, WiFi, Near Field communications, ZigBee, or any other suitable wireless communication method.

The one or more remote motion sensors (hereinafter “remote motion sensor” or “remote motion sensors”) 124 associated with the point of sale terminal 106 can be configured to remotely sense the motion of the mobile device 104 as the customer 112 moves the mobile device 104 through space. The remote motion sensors 124 can be configured to generate one or more motion signals representative of the motion of the mobile device 104 as it is moved through space by the customer 112. The remote motion sensors 124 may be fixed in space and may remotely observe the mobile device 104 from one or more fixed positions. The remote motion sensors 124 can be configured to generate one or more electronic signals representative of the motion of the mobile device 104 as it moves through space and the point of sale terminal 106 may capture and record these electronic signals in memory as remote motion signal data 224 (see FIG. 2), which can be a subset of the verification data 126 shown in FIG. 1. The remote motion sensor 124 can include any sensor that allows the motion of the mobile device 104 to be remotely sensed as the customer 112 moves the mobile device 104 through space. In these and other embodiments, the remote motion sensor 124 can include one or more of: an array of antennas (not shown) configured to wirelessly locate the mobile device, one or more cameras (not shown) that capture visual images of the mobile device, one or more time-of-flight cameras (not shown), and one or more structured light projections (not shown). Examples of each of these remote sensing technologies will be explained below.

In example embodiments that utilize wireless localization, the motion of the mobile device 104 may be tracked with an array of antennas included in the remote motion sensor 124. The array of antennas can include any number of antennas geometrically arranged in fixed positions. Furthermore, various wireless localization techniques that utilize an array of antennas can be used to track the location of the mobile device 104, including one or more of: measuring a time-of-arrival (TOA) for a transmitted signal, measuring an angle of arrival (AOA) for a transmitted signal, measuring a power or received signal strength (RSS) for a transmitted signal, or other suitable wireless localization technique. For wireless localization techniques that utilize the TOA technique, the mobile device 104 may emit a wireless signal as the customer 112 moves the mobile device 104 through space, which may then be sensed by the array of antennas. The path lengths between each of the antennas in the array and the mobile device 104 will change as the mobile device 104 moves through space. Thus, the wireless signal that the mobile device 104 emits will arrive at different times at each of the antennas as the mobile device 104 moves through space. The differences in the time of arrival for each antenna correspond to the distance between the mobile device 104 and each antenna. Because the geometric locations of the array of antennas are known, the geometric location of the mobile device 104 can be determined. Accordingly, these different arrival times can be used to track the position of the mobile device 104 through space and time. Similarly, wireless localization techniques that utilize the angle of arrival technique can use an array of antennas to measure the angle of arrival of the signal transmitted by the mobile device 104 for each antenna and, because the geometric locations of the array of antennas are known, the geometric location of the mobile device 104 can be determined through triangulation. Wireless localization techniques that utilize received signal strength measurements can also utilize an array of antennas that measure the received signal strength emitted from the mobile device 104. The received signal strength can depend on the distance of the mobile device 104 from each antenna. Accordingly, these different received signal strengths, along with the known geometric locations of the array of antennas, can be used to track the position of the mobile device 104 through space and time.

In example implementations that utilize one or more cameras that capture visual images of the mobile device 104, various techniques can be used to track the motion and/or location of the mobile device 104 with the one or more cameras included in the remote motion sensor 124. In an example, passive triangulation methods can be used with two or more cameras fixed at known positions. Multiple images of the mobile device 104 can be taken with the different cameras as the mobile device 104 moves through space. Image processing and/or computer vision algorithms can be used to identify the mobile device 104, or one or more feature points of the mobile device 104 (e.g., a corner of the mobile device 104, a surface of the mobile device 104, a color of the mobile device 104, or other suitable feature of the mobile device 104). After the feature points of the mobile device 104 are identified, their relative positions and locations can be found in each of the multiple images. The location and motion of the mobile device 104 can then be calculated for each point in space corresponding to the multiple images using triangulation techniques.

In example embodiments that utilize one or more time-of-flight depth cameras included in the remote motion sensor 124, the motion of the mobile device 104 can be determined by accurately measuring a time it takes light to travel to the mobile device 104 and then back to the time-of-flight depth camera. In this manner, the path length that the light travels can be determined from the time it takes the light to travel to the mobile device 104 and then back to the time-of-flight depth camera. The location and motion of the mobile device 104 can then be sensed for each point in space using triangulation techniques, similar to the techniques discussed above.

In example embodiments utilizing one or more structured light projections, the motion of the mobile device 104 can be determined by projecting a light pattern on the mobile device 104 and/or on a scene around the mobile device 104. Two or more cameras included in the remote motion sensor 124 can then observe the scene, which reflects the structured light pattern, and a depth map of the scene can be created by the two or more cameras observing the structured light pattern such that a correspondence can be made between different points observed by the cameras and a depth map can be constructed by exploiting the parallax effect. The depth map and images of the mobile device 104 may be recorded together as the mobile device 104 moves through space and the motion of the mobile device 104 may be extracted from these images via image processing techniques.

Continuing with FIG. 1, the payment server 108 may host a motion verification application 132 and verification data 134. The verification data 134 may include payment transaction data 114, such as authentication information specific to the customers 112 including PINs, public and/or private digital signatures, public and/or private keys, as well as any other data that may be used to facilitate electronic payment transactions. This information may be sent to and/or received from the mobile devices 104 and the point of sale terminal 106 during electronic payment transactions. Although the payment server 108 is illustrated in FIG. 1, some implementations do not require a payment server 108 to help facilitate electronic payment transactions such that the payment server 108 may be omitted.

The motion verification application 132 may be configured to detect relay attacks, which will be discussed in greater detail below with respect to FIG. 2. The motion verification application 132 may provide a server-based version of the motion verification application 122, e.g., for use in a client-server relationship between the point of sale terminal 106 and the payment server 108. In some implementations, the motion verification application 122 of the point of sale terminal may generally include client-side components associated with facilitating electronic payment transactions while the motion verification application 132 of the payment server 108 may generally include server-side components associated with facilitating electronic payment transactions.

In some implementations, one or both of the motion verification applications 122, 132 may be implemented using hardware including a field-programmable gate array (FPGA) or an application-specific integrated circuit (ASIC). In some other implementations, one or both of the motion verification applications 122, 132 may be implemented using a combination of hardware and software. The motion verification applications 122, 132 may be stored in a combination of the devices and servers, or in one of the devices or servers of FIG. 1. An example implementation of a motion verification application that may correspond to one or both of the motion verification applications 122, 132 is described below in more detail.

FIG. 2 is a block diagram illustrating an example relay attack defense support system (hereinafter “system”) 200 to defend against relay attacks, arranged in accordance with at least some embodiments described herein. The system 200 may include or correspond to the point of sale terminal 106 of FIG. 1. The system 200 may be implemented as a computing device having any suitable form factor, such as a desktop computer, a laptop computer, a tablet computer, a mobile phone, a smartphone, a personal digital assistant (PDA), an e-reader device, or other suitable computing device.

The system 200 may include a motion verification application 202, one or more remote motion sensors 220, a processor device 204, a communication interface 206, one or more transmitters 214, one or more receivers 218, a storage 208, and a memory 210 according to some examples. The components of the system 200 may be communicatively coupled by a bus 212. The bus 212 may include one or more of: a memory bus, a storage interface bus, a bus/interface controller, an interface bus, or other suitable bus. In some implementations, the system 200 additionally includes a display device 216 that may be configured to display instructions and/or other electronic payment transaction information to a customer 112.

The processor device 204 can include an arithmetic logic unit, a microprocessor, a general-purpose controller, or some other processor array to perform or control performance of operations as described herein. The processor device 204 processes data signals and may include various computing architectures including a complex instruction set computer (CISC) architecture, a reduced instruction set computer (RISC) architecture, or an architecture implementing a combination of instruction sets. Although FIG. 2 includes a single processor device 204, multiple processor devices may be included. Other processors, operating systems, and physical configurations may be possible.

The memory 210 stores instructions or data that may be executed or operated on by the processor device 204. The instructions or data may include programming code that may be executed by the processor device 204 to perform or control performance of the operations described herein. The memory 210 may include a dynamic random access memory (DRAM) device, a static random access memory (SRAM) device, flash memory, or some other memory device. In some implementations, the memory 210 also includes a non-volatile memory or similar permanent storage and media including a hard disk drive, a floppy disk drive, a CD-ROM device, a DVD-ROM device, a DVD-RAM device, a DVD-RW device, a flash memory device, or some other mass storage for storing information on a more permanent basis.

The memory 210 may store verification data 222. The verification data 222 may include the remote motion signal data 224, in-situ motion signal data 226, and payment transaction data 228. The verification data 222 may correspond to the verification data 126 of FIG. 1. Alternately or additionally, the payment transaction data 228 may correspond to the payment transaction data 114 and/or the in-situ motion signal data 226 may correspond to the in-situ motion signal data 111 of FIG. 1. The payment transaction data 228 may include data that uniquely identifies one or more of the customers 112. For example, the payment transaction data 228 may include one or more of a PIN, a digital signature, a key, a name, a username, an address, an e-mail address, a mobile phone number, a date of birth, or other information associated with the corresponding customer 112.

The communication interface 206 may transmit and receive data to and from at least one of the payment server 108 and the mobile devices 104 of FIG. 1. In some implementations, the communication interface 206 includes a port for direct physical connection to the network 102 of FIG. 1 or to another communication channel. For example, the communication interface 206 may include a universal serial bus (USB) port, a secure digital (SD) port, a category 5 cable (CAT-5) port, or similar port for wired communication with the mobile device 104 and/or the payment server 108 of FIG. 1. In some implementations, the communication interface 206 includes a wireless transmitter 214 and receiver 218 for exchanging data with at least one of the mobile devices 104 and/or the payment server 108 of FIG. 1 or other communication channels using one or more wireless communication methods, including IEEE 802.11, IEEE 802.16, BLUETOOTH®, WiFi, Near Field communications, ZigBee, or any other suitable wireless communication method.

In some implementations, the communication interface 206 includes a cellular communications transceiver for sending and receiving data over a cellular communications network including via short messaging service (SMS), multimedia messaging service (MMS), hypertext transfer protocol (HTTP), direct data connection, wireless application protocol (WAP), e-mail, or another suitable type of electronic communication. In some implementations, the communication interface 206 includes a wired port and a wireless transceiver. The communication interface 206 may also provide other connections to the network 102 of FIG. 1 for data communication using standard network protocols including transmission control protocol/internet protocol (TCP/IP), HTTP, HTTP secure (HTTPS), and simple mail transfer protocol (SMTP), etc.

The storage 208 may include a non-transitory storage medium that stores instructions and/or data for providing the functionality described herein. The storage 208 may include a dynamic random access memory (DRAM) device, a static random access memory (SRAM) device, flash memory, or some other memory devices. In some implementations, the storage 208 also includes a non-volatile memory or similar permanent storage and media including a hard disk drive, a floppy disk drive, a CD-ROM device, a DVD-ROM device, a DVD-RAM device, a DVD-RW device, a flash memory device, or some other mass storage for storing information on a more permanent basis. The storage 208 may also store instructions and/or data that are temporarily stored or loaded into the memory 210.

As illustrated in FIG. 2, the motion verification application 202 may include at least one of: an extractor module 232, a recorder module 234, a decryption module 236, a motion analysis module 240, a comparison module 242, a verification module 244, and an alarm module 246, collectively referred to herein as “modules” 230. The motion verification application 202, including the modules 230, may generally include software that includes programming code and/or computer-readable instructions executable by the processor device 204 to perform or control performance of the functions and operations described herein. The motion verification application 202, including one or more of the modules 230, may receive data from another one of the components of the system 200 and may store the data in one or both of the storage 208 and the memory 210.

The extractor module 232 may generally be configured to extract payment transaction data 228 that has been associated with in-situ motion signal data 226, as described in more detail herein. The recorder module 234 may generally be configured to receive motion signals from the remote motion sensor(s) 220 and record these motion signals as the remote motion signal data 224, as described in more detail herein. The decryption module 236 may generally be configured to decrypt data that has been encrypted, as described in more detail herein. The motion analysis module 240 may generally be configured to analyze motion signals, as described in more detail herein. The comparison module 242 may generally be configured to compare two motion signals to each other and calculate a correlation between the two motion signals, as described in more detail herein. The verification module 244 may generally be configured to verify that the correlation between the two motion signals indicates that the two motion signals are substantially similar to each other, as described in more detail herein. The alarm module 246 may generally be configured to generate an alarm signal in response to the correlation not being indicative that the two motion signals are substantially similar to each other and to indicate that a relay attack is detected.

An example implementation that involves the system 200 of FIG. 2 implemented as the point of sale terminal 106 in the operating environment 100 of FIG. 1 will now be discussed. With combined reference to FIG. 1 and FIG. 2, the customer 112 may approach the point of sale terminal 106 (or the system 200) to purchase an item. An electronic payment transaction may be initiated and the customer 112 may receive instructions to “create a unique motion” with his or her mobile device 104. The instructions to create the unique motion with the mobile device 104 may be sent to the customer 112 through the mobile device 104 and/or through the point of sale terminal 106 (or system 200) through the display device 216 or one or more sound producing devices (not shown) associated with the mobile device 104 or the point of sale terminal 106. The customer 112 then makes a unique motion with the mobile device 104 according to the instructions. As the customer 112 is making the unique motion, the remote motion sensor 124 (or 220) and the in-situ motion sensor 110 simultaneously record the motion of the mobile device 104.

The recorder module 234 can be configured to receive remote motion signals from the remote motion sensor 124 (or 220) and record this information as remote motion signal data 224 in memory 210. Likewise, the mobile device 104 can be configured to receive and record in-situ motion signals from the in-situ motion sensor 110 and record this information as in-situ motion signal data 111. The mobile device 104 can then send the in-situ motion signal data 111, along with the payment transaction data 114, to the point of sale terminal 106 embodied in system 200. Alternately, the mobile device 104 can send the in-situ motion signal data 111 separately from the payment transaction data 114. The data received from the mobile device 104 may then be stored in the memory 210 as the verification data 126 (or 222), which may include the in-situ motion signal data 226 and the payment transaction data 228.

Referring again to FIG. 2, the decryption module 236 can include or implement any suitable decryption method. Moreover, the system 200 can be configured to store the verification data 222 in the memory 210 in its encrypted state and to instruct the decryption module 236 to decrypt the verification data 222 when the verification data 222 is needed by the appropriate one of the modules 230.

As previously mentioned, the extractor module 232 may be configured to extract the payment transaction data 228 that is associated with the in-situ motion signal data 226. For example, the payment transaction data 228 can be associated with the in-situ motion signal data 226 by appending the payment transaction data 228 to the beginning or end of the in-situ motion signal data 226, or by mixing the payment transaction data 228 anywhere within the in-situ motion signal data 226. The extractor module 232 can be configured to differentiate and extract the payment transaction data 228 from the in-situ motion signal data 226.

The motion analysis module 240 can be configured to access the remote motion signal data 224 (or motion signal) and the in-situ motion signal data 226 (or motion signal) and compare these two motion signals to each other at comparison module 242. The two motion signals may be defined relative to each other by an arbitrarily chosen reference frame. For example, the initial position of the mobile device 104 may be selected to be the center position of the arbitrarily chosen reference frame. This reference frame can be stationary with the respect to the remote motion sensors 220 of the system 200 (or with respect to the remote motion sensors 124 of the point of sale terminal 106).

The motion of the mobile device 104 may then be defined by three translational coordinates x, y, z and/or three rotational coordinates φ, θ, γ. The mobile device 104 and the system 200 or the point of sale terminal 106 may each record one or more of these coordinates. For example, the mobile device 104 may use accelerometers to record the x, y, z coordinates and gyroscopes to record the rotational coordinates φ, θ, γ, as discussed above. The system 200 or point of sale terminal 106 may also use its remote motion sensors 124 or 220 to record x, y, z, and φ, θ, γ coordinates of the mobile device 104. Furthermore, each of these coordinates can be parameterized as a function of time. For instance the x translational coordinate may be parameterized as x(t) and the φ rotational coordinate as φ (t). A motion signal may be defined as any subset of these six possible functions. For example, one or more motion signals recorded by the mobile device 104 can include one or more parameterized signals xₘ(t), yₘ(t), zₘ(t), φₘ(t), θₘ(t), γₘ(t) and one or more motion signals recorded by the system 200 or the point of sale terminal 106 may include one or more parameterized signals xₚ(t), yₚ(t), zₚ(t), φₚ(t), θₚ(t), γₚ(t). The mobile device 104 can send its parameterized signals, or a subset of these signals, to the system 200 or the point of sale terminal 106 for comparison against corresponding parameterized signals recorded by the system 200 or the point of sale terminal 106. In addition, digital measurements can be made at discrete instances of t, resulting in a discrete number of vector values for each of the parameterized coordinate signals. In this case, the corresponding vector values for each of the two motion signals may be compared to each other. In some examples, the distances between the two motion signals may be compared to each other in order to determine how similar the two motion signals are to each other. In a particular example, the distances between individual coordinates can be compared to each other. For example, the distances between xₘ(t) and xₚ(t) can be compared to each other. Likewise, the distances between other individual coordinates can be compared to each other. In this manner, one or more correlation values between the individual coordinates of the motion signals can be generated in order to determine how similar the two motion signals are to each other.

The comparison module 242 can send the one or more correlation values or distance values to the verification module 244, which can be configured to compare the one or more correlation values or distance values against one or more predetermined error values in order to determine if the two motion signals are substantially similar to each other. For example, a predetermined error value of no more than 5% may be chosen to provide a reasonable trade-off to keep both the false acceptance rate and false rejection rate as low as possible.

The alarm module 246 may be configured to generate an alarm signal if one or more of the predetermined error values are exceeded. The alarm signal may alternately or additionally cause the electronic payment transaction to abort. The alarm signal may alternately or additionally cause a warning message to be sent to the proper parties and/or authorities to alert them that the point of sale terminal 106 has detected a relay attack event.

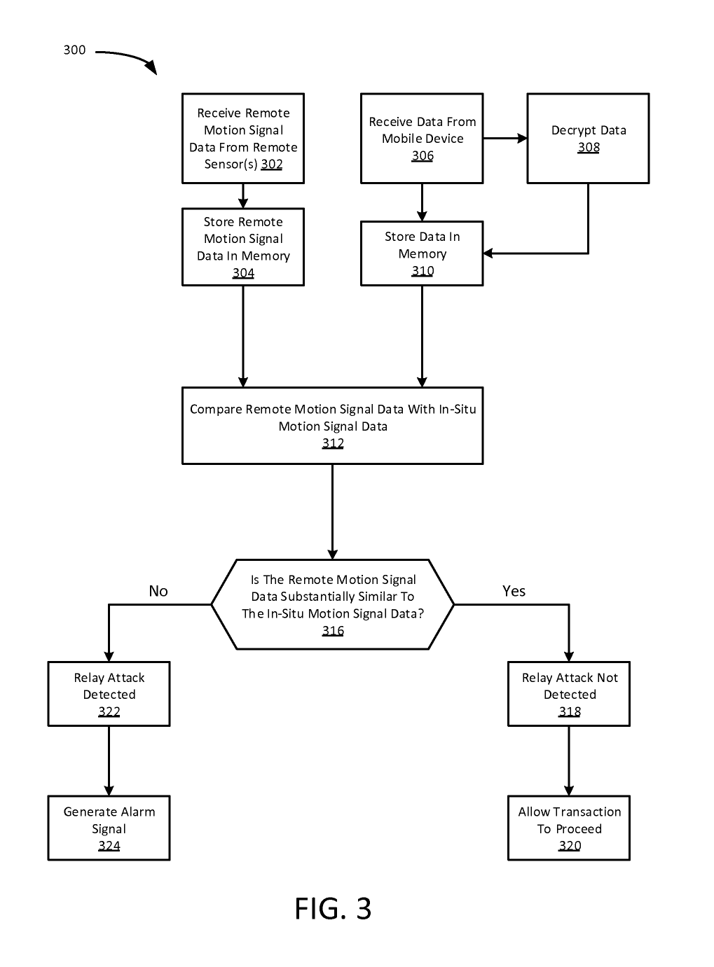

FIG. 3 shows an example flow diagram of a method 300 to defend against relay attacks, arranged in accordance with at least some embodiments described herein. The method 300 may be implemented, in whole or in part, by one or more of the point of sale terminal 106 and the payment server 108 of FIG. 1, the system 200 of FIG. 2, or another suitable device, server, and/or system. The method 300 may begin at block 302.

In block 302 (“Receive Remote Motion Signal Data From Remote Sensor(s)”), remote motion signal data may be received from one or more remote motion sensors associated with a point of sale terminal, such as the point of sale terminal 106 of FIG. 1 or the system 200 of FIG. 2. The remote motion sensors may be implemented using wireless localization with an antenna array, with visual or time-of-flight cameras, structured light projections, or any other remote motion sensor technology discussed herein. The remote motion sensors may correspond to the remote motion sensors 124, 220 of FIGS. 1 and 2. Block 302 may be followed by block 304.

In block 304 (“Store Remote Motion Signal Data In Memory”), the remote motion signal data may be stored in the memory of the point of sale terminal 106. The remote motion signal data may be included in or correspond to the verification data 126 of FIG. 1, or the Verification data 222 or remote motion signal data 224 of FIG. 2. Block 304 may be followed by block 312 discussed below.

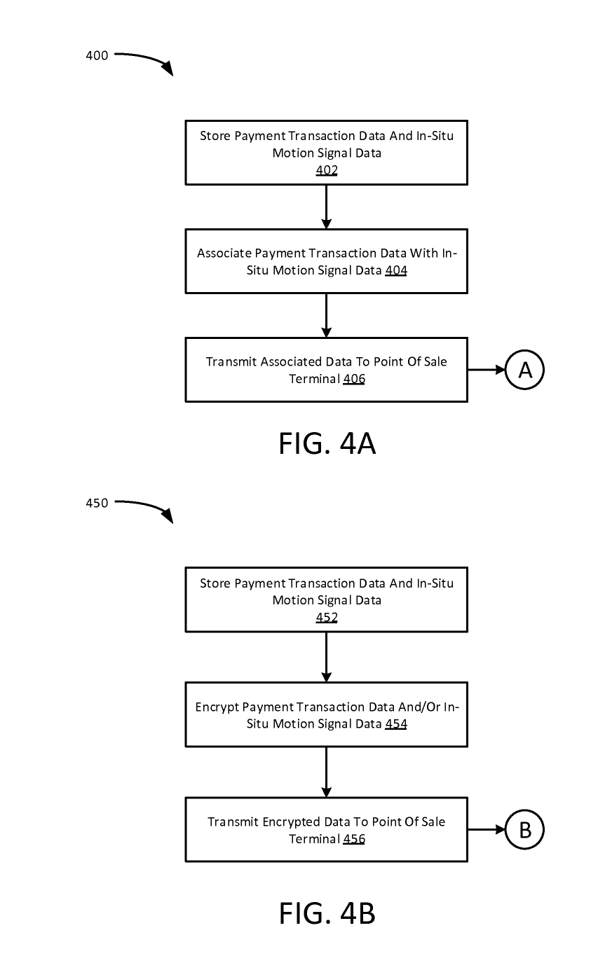

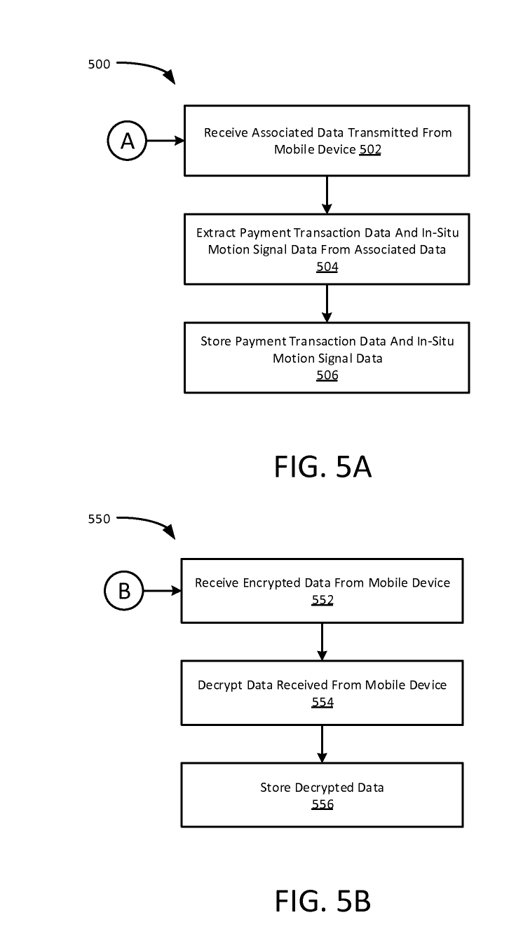

In block 306 (“Receive Data From Mobile Device”), the point of sale terminal may receive data from a mobile device 104. The data may be included in or correspond to the in-situ motion signal data 111, payment transaction data 114, or verification data 126 of FIG. 1 or the in-situ motion signal data 226 or payment transaction data 228 of FIG. 2. The data received from the mobile device 104 may include payment transaction data associated with the in-situ motion signal data. An example method to associate payment transaction data with in-situ motion signal data is described in FIG. 4A below. Furthermore, an example method to disassociate payment transaction data from in-situ motion signal data is described in FIG. 5A below. Block 306 may be followed by block 308.

In block 308 (“Decrypt Data”), the point of sale terminal may decrypt the data received from the mobile device in block 306, as needed. The decryption process may include any decryption process known in the art which may also be included in or correspond to the decryption module 236 of FIG. 2. An example method to encrypt data at the mobile device 104 is described in FIG. 4B below. Furthermore, an example method to decrypt data at the point of sale terminal 106 is described in FIG. 5B below. Block 308 may be followed by block 310

In block 310 (“Store Data In Memory”), the point of sale terminal 106 may store the received data from the mobile device in memory. The data may be stored in memory as encrypted or decrypted data. Block 310 may be followed by block 312.

In block 312 (“Compare Remote Motion Signal Data With In-Situ Motion Signal Data”), the remote motion signal data can be compared to the in-situ motion signal data, as discussed above with reference to the comparison module 242 of FIG. 2. Comparing the remote motion signal data to the in-situ motion signal data may include calculating one or more correlations or distances between the remote motion signal data and the in-situ motion signal data, as previously discussed with reference to the comparison module 242 of FIG. 2. Block 312 may be followed by block 316.

In block 316 (“Is The Remote Motion Signal Data Substantially Similar To The In-Situ Motion Signal Data?”), the one or more correlations or distances between the remote motion signal data and the in-situ motion signal data may be compared to one or more predetermined error values in order to determine whether the remote motion signal data is substantially similar to the in-situ motion signal data, as previously discussed with reference to the verification module 244 of FIG. 2. Block 316 may be followed by block 318 (“Yes” at block 316) or by block 322 (“No” at block 316) depending on whether the two motion signals are substantially similar enough to each other.

In block 318 (“Relay Attack Not Detected”), if it is determined at block 316 that the two motion signals are substantially similar to each other, no relay attack may be detected. Block 318 may be followed by block 320.

In block 320 (“Allow Transaction To Proceed”), the electronic payment transaction is allowed to proceed.

In block 322 (“Relay Attack Detected”), if it is determined at block 316 that the two motion signals are not substantially similar enough to each other (“No” at block 316 in FIG. 3), a relay attack may be detected. Block 322 may be followed by block 324.

In block 324 (“Generate Alarm Signal”), an alarm signal can be generated that may cause the electronic payment transaction to abort and/or may send an alert message to the proper parties that a relay attack was attempted at the point of sale terminal 106.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed implementations.

FIG. 4A shows an example flow diagram of a method 400 to associate payment transaction data with motion signal data at a mobile device, arranged in accordance with at least some embodiments described herein. The mobile device may correspond to one or more of the mobile devices 104 of FIG. 1. The method 400 may be implemented, in whole or in part, by one or more of the mobile devices 104 of FIG. 1 or another suitable device, server, and/or system. For convenience in the discussion that follows, the method 400 of FIG. 4A is discussed in the context of FIG. 1. The method 400 may begin at block 402.

In block 402 (“Store Payment Transaction Data And In-Situ Motion Signal Data”), payment transaction data and in-situ motion signal data are stored on the mobile device 104. The payment transaction data may correspond to the payment transaction data 114 of FIG. 1 and the in-situ motion signal data may correspond to the in-situ motion signal data 111 of FIG. 1. Block 402 may be followed by block 404.

In block 404 (“Associate Payment Transaction Data With In-Situ Motion Signal Data”), the payment transaction data 114 can be associated with the in-situ motion signal data 111 by appending the payment transaction data 114 to the beginning or end of the in-situ motion signal data 111, or by mixing the payment transaction data 114 anywhere within the in-situ motion signal data 111. Block 404 may be followed by block 406.

In block 406 (“Transmit Associated Data To Point Of Sale Terminal”), the associated data can be transmitted from the mobile device 104 to the point of sale terminal 106 and disassociated or extracted, as described with respect to FIG. 5A discussed below.

FIG. 4B shows an example flow diagram of a method 450 to encrypt payment transaction data and/or in-situ motion signal data at a mobile device, arranged in accordance with at least some embodiments described herein. The mobile device may correspond to one or more of the mobile devices 104 of FIG. 1. The method 450 may be implemented, in whole or in part, by one or more of the mobile devices 104 of FIG. 1 or another suitable device, server, and/or system. For convenience in the discussion that follows, the method 450 of FIG. 4B is discussed in the context of FIG. 1. The method 450 may begin at block 452.

In blocks 452 (“Store Payment Transaction Data And In-Situ Motion Signal Data”), payment transaction data and in-situ motion signal data are stored on the mobile device 104. The payment transaction data may correspond to the payment transaction data 114 of FIG. 1 and the in-situ motion signal data may correspond to the in-situ motion signal data 111 of FIG. 1. Block 452 may be followed by block 454.

In block 454 (“Encrypt Payment Transaction Data And/Or In-Situ Motion Signal Data”), the payment transaction data and/or in-situ motion signal data can be encrypted. The encryption process may include any suitable encryption process. Block 454 may be followed by block 456.

In block 456 (“Transmit Encrypted Data To Point Of Sale Terminal”), the encrypted data can be transmitted from the mobile device 104 to the point of sale terminal 106 for decryption, as described with respect to FIG. 5B below.

The methods 400 and 450 of FIGS. 4A and 4B may be combined in some embodiments. For instance, the associated data transmitted to the point of sale terminal 106 at block 406 in the method 400 of FIG. 4A may be encrypted prior to transmission, as described with respect to block 454 of FIG. 4B.

FIG. 5A shows an example flow diagram of a method 500 to extract or disassociate payment transaction data from motion signal data received from a mobile device, arranged in accordance with at least some embodiments described herein. The method 500 may be implemented, in whole or in part, by one or more of the point of sale terminal 106 or payment server 108 of FIG. 1, the system 200 of FIG. 2, or another suitable device, server, and/or system. For convenience in the discussion that follows, the method 500 of FIG. 5A is discussed in the context of FIG. 1. The method 500 may begin at block 502.

In block 502 (“Receive Associated Data Transmitted From Mobile Device”), associated payment transaction data and in-situ motion signal data are received from the mobile device 104. The payment transaction data may correspond to the payment transaction data 114 of FIG. 1 and the in-situ motion signal data may correspond to the in-situ motion signal data 111 of FIG. 1. Block 502 may be followed by block 504.

In block 504 (“Extract Payment Transaction Data And In-Situ Motion Signal Data From Associated Data”), the payment transaction data and the in-situ motion signal data can be extracted from the associated data, or disassociated from each other, by identifying and differentiating the payment transaction data from the in-situ motion signal data. Block 504 may be followed by block 506.

In block 506 (“Store Payment Transaction Data And In-Situ Motion Signal Data”), the payment transaction data and the in-situ motion signal data may be stored on the point of sale terminal 106. The payment transaction data and the in-situ motion signal data may be stored separately, together as associated data, or both separately and together as associated data.

FIG. 5B shows an example flow diagram of a method 550 to decrypt payment transaction data and/or in-situ motion signal data at a point of sale terminal 106, arranged in accordance with at least some embodiments described herein. The method 550 may be implemented, in whole or in part, by one or more of the point of sale terminal 106 or payment server 108 of FIG. 1, the system 200 of FIG. 2, or another suitable device, server, and/or system. For convenience in the discussion that follows, the method 550 of FIG. 5B is discussed in the context of FIG. 1. The method 550 may begin at block 552.

In block 552 (“Receive Encrypted Data From Mobile Device”), encrypted data is received from the mobile device 104. The encrypted data may correspond to the payment transaction data 114 and in-situ motion signal data 111 of FIG. 1. Block 552 may be followed by block 554.

In block 554 (“Decrypt Data Received From Mobile Device”), the encrypted data may be decrypted. The decryption process may include any suitable decryption process. Block 554 may be followed by block 556.

In block 556 (“Store Decrypted Data”), the decrypted data can be stored on the point of sale terminal 106.

The implementations described herein may include the use of a special purpose or general-purpose computer including various computer hardware or software modules, as discussed in greater detail below.

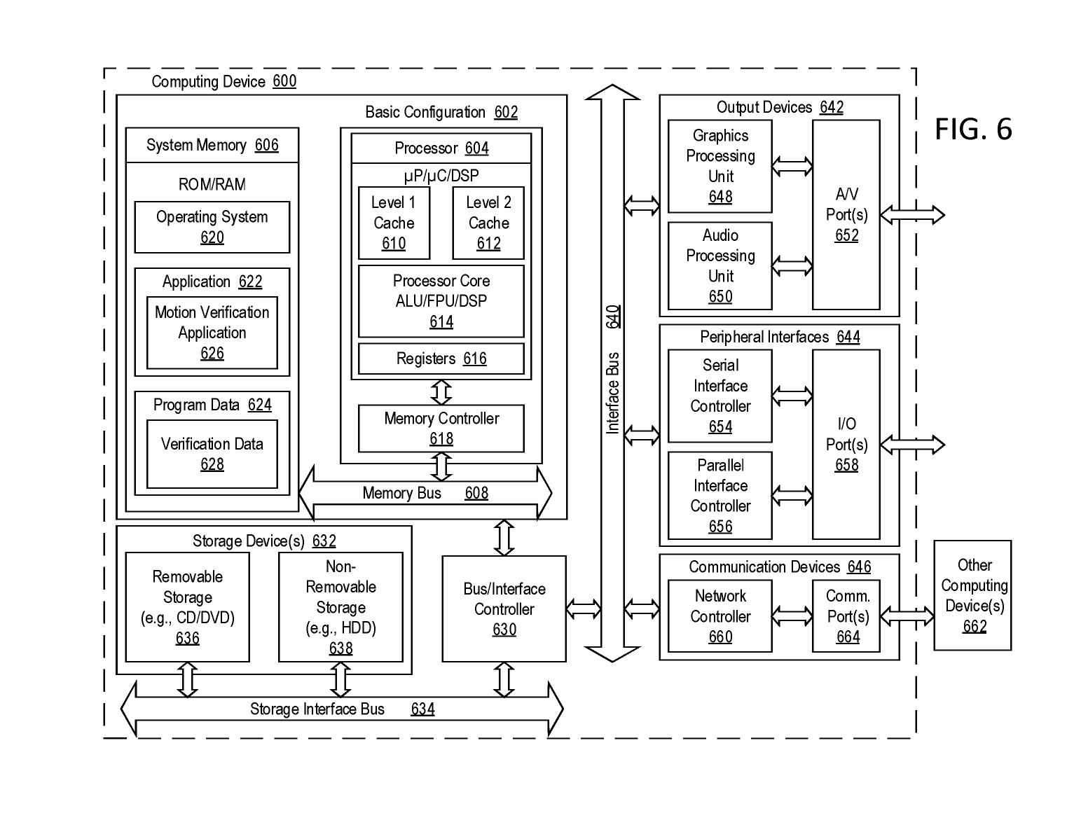

FIG. 6 is a block diagram illustrating an example computing device 600 that is arranged to detect relay attacks, arranged in accordance with at least some embodiments described herein. In a very basic configuration 602, computing device 600 typically includes one or more processors 604 and a system memory 606. A memory bus 608 may be used for communicating between processor 604 and system memory 606.

Depending on the desired configuration, processor 604 may be of any type including a microprocessor (μP), a microcontroller (μC), a digital signal processor (DSP), or any combination thereof. Processor 604 may include one or more levels of caching, such as a level one cache 610 and a level two cache 612, a processor core 614, and registers 616. The example processor core 614 may include an arithmetic logic unit (ALU), a floating point unit (FPU), a digital signal processing core (DSP Core), or any combination thereof. An example memory controller 618 may also be used with processor 604, or in some implementations memory controller 618 may be an internal part of processor 604.

Depending on the desired configuration, system memory 606 may be of any type including volatile memory (such as RAM), nonvolatile memory (such as ROM, flash memory, etc.), or any combination thereof. System memory 606 may include an operating system 620, one or more applications 622, and program data 624. Application 622 may include a motion verification application 626 that may correspond to the motion verification application 122, 202 of FIGS. 1 and 2. Program data 624 may include verification data 628 that may correspond to the verification data 126 and 222 of FIGS. 1 and 2. In some embodiments, application 622 may be arranged to operate with program data 624 on operating system 620 to perform a method to defend against relay attacks, such as the method 300 of FIG. 3, and/or to perform other methods and/or operations described herein.

Computing device 600 may have additional features or functionality, and additional interfaces to facilitate communications between basic configuration 602 and any required devices and interfaces. For example, a bus/interface controller 630 may be used to facilitate communications between basic configuration 602 and one or more data storage devices 632 via a storage interface bus 634. Data storage devices 632 may be removable storage devices 636, non-removable storage devices 638, or a combination thereof. Examples of removable storage and non-removable storage devices include magnetic disk devices such as flexible disk drives and hard-disk drives (HDDs), optical disk drives such as compact disk (CD) drives or digital versatile disk (DVD) drives, solid state drives (SSDs), and tape drives to name a few. Example computer storage media may include volatile and nonvolatile, removable and non-removable media implemented in any method or technology for storage of information, such as computer-readable instructions, data structures, program modules, or other data.

System memory 606, removable storage devices 636, and non-removable storage devices 638 are examples of computer storage media. Computer storage media includes RAM, ROM, EEPROM, flash memory or other memory technology, CD-ROM, digital versatile disks (DVDs) or other optical storage, magnetic cassettes, magnetic tape, magnetic disk storage or other magnetic storage devices, or any other medium which may be used to store the desired information and which may be accessed by computing device 600. Any such computer storage media may be part of computing device 600.

Computing device 600 may also include an interface bus 640 for facilitating communication from various interface devices (e.g., output devices 642, peripheral interfaces 644, and communication devices 646) to basic configuration 602 via bus/interface controller 630. Example output devices 642 include a graphics processing unit 648 and an audio processing unit 650, which may be configured to communicate to various external devices such as a display or speakers via one or more A/V ports 652. Example peripheral interfaces 644 include a serial interface controller 654 or a parallel interface controller 656, which may be configured to communicate with external devices such as input devices (e.g., keyboard, mouse, pen, voice input device, touch input device, etc.), sensors (e.g., motion sensors 110, 124, and/or 220 of FIGS. 1 and 2), or other peripheral devices (e.g., printer, scanner, etc.) via one or more I/O ports 658. An example communication device 546 includes a network controller 660, which may be arranged to facilitate communications with one or more other computing devices 662 over a network communication link via one or more communication ports 664.

The network communication link may be one example of a communication media. Communication media may typically be embodied by computer-readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term “computer-readable media” as used herein may include both storage media and communication media.

Computing device 600 may be implemented as a portion of a small-form factor portable (or mobile) electronic device such as a cell phone, a personal data assistant (PDA), a personal media player device, a wireless web-watch device, a personal headset device, an application-specific device, or a hybrid device that includes any of the above functions. Computing device 600 may also be implemented as a personal computer including both laptop computer and non-laptop computer configurations. The computing device 600 of FIG. 6 can be an example implementation of the mobile devices 104, the point of sale terminal 106, the payment server 108, and/or the system 200 of FIGS. 1 and 2.

The present disclosure is not to be limited in terms of the particular embodiments described herein, which are intended as illustrations of various aspects. Many modifications and variations can be made without departing from its spirit and scope. Functionally equivalent methods and apparatuses within the scope of the disclosure, in addition to those enumerated herein, are possible from the foregoing descriptions. Such modifications and variations are intended to fall within the scope of the appended claims. The present disclosure is to be limited only by the terms of the appended claims, along with the full scope of equivalents to which such claims are entitled. It is to be understood that the present disclosure is not limited to particular methods, reagents, compounds compositions, or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible sub ranges and combinations of sub ranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into sub ranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, various embodiments of the present disclosure have been described herein for purposes of illustration, and various modifications may be made without departing from the scope and spirit of the present disclosure. Accordingly, the various embodiments disclosed herein are not intended to be limiting, with the true scope and spirit being indicated by the following claims.

1. A method to defend against relay attacks, the method comprising:
recording a first motion signal of a motion of a mobile device, wherein the first motion signal is generated by remotely sensing the motion of the mobile device at a system or device that is separate and remote from the mobile device;
receiving data that includes a second motion signal of the motion of the mobile device, wherein the second motion signal is generated by sensing the motion of the mobile device in-situ at the mobile device;
comparing the first motion signal with the second motion signal; and
verifying, based on a result of the comparison, that a relay attack is not present when the first motion signal is substantially similar to the second motion signal.

2. The method according to claim 1, wherein remotely sensing the motion of the mobile device comprises wirelessly locating the mobile device with an array of antennas.

3. The method according to claim 1, wherein remotely sensing the motion of the mobile device comprises processing image signals received from one or more cameras to sense the motion of the mobile device.

4. The method according to claim 1, wherein sensing the motion of the mobile device in-situ comprises processing motion signals received from one or more accelerometers associated with the mobile device to sense the motion of the mobile device.

5. The method according to claim 1, wherein sensing the motion of the mobile device in-situ comprises processing motion signals received from one or more gyroscopes associated with the mobile device to sense the motion of the mobile device in-situ.

6. The method according to claim 1, wherein the received data that includes the second motion signal further includes payment transaction data associated with the second motion signal.

7. The method according to claim 6, wherein the payment transaction data comprises at least one of a PIN, a digital signature, and a key.

8. The method according to claim 6, wherein at least one of the payment transaction data and the second motion signal is encrypted.

9. The method according to claim 1, further comprising generating an alarm signal when the first motion signal is not substantially similar to the second motion signal.

10. A system to defend against relay attacks, the system comprising:
at least one remote sensor configured to remotely sense a motion of a mobile device and to generate a first motion signal of the motion of the mobile device, wherein the at least one remote sensor is separate and remote from the mobile device;
a recorder module configured to be in electronic communication with the at least one remote sensor and configured to record the first motion signal;
a receiver configured to receive data that includes a second motion signal of the motion of the mobile device, wherein the second motion signal is generated by sensing the motion of the mobile device in-situ at the mobile device; and
a motion analysis module configured to:
compare the first motion signal with the second motion signal; and
verify, based on a result of the comparison, that a relay attack is not present when the first motion signal is substantially similar to the second motion signal.

11. The system according to claim 10, wherein the at least one remote sensor comprises one or more receivers adapted to be in electronic communication with an array of antennas and configured to remotely sense the motion of the mobile device through wireless localization.

12. The system according to claim 10, wherein the at least one remote sensor comprises one or more cameras configured to remotely sense the motion of the mobile device.

13. The system according to claim 10, wherein the motion of the mobile device is configured to be sensed in-situ through one or more accelerometers associated with the mobile device.

14. The system according to claim 10, wherein the motion of the mobile device is configured to be sensed in-situ through one or more gyroscopes associated with the mobile device.

15. The system according to claim 10, wherein the received data that includes the second motion signal further includes payment transaction data associated with the second motion signal.

16. The system according to claim 15, wherein the payment transaction data comprises at least one of a PIN, a digital signature, and a key.

17. The system according to claim 15, wherein at least one of the payment transaction data and the second motion signal is encrypted, the system further comprising a decryption module configured to decrypt the encrypted at least one of the payment transaction data and the second motion signal.

18. The system according to claim 10, wherein the motion analysis module comprises an alarm module configured to generate an alarm signal when the first motion signal is not substantially similar to the second motion signal.

19. A non-transitory computer-readable medium that includes computer-readable instructions stored thereon that are executable by a processor to perform or control performance of operations comprising:
recording a first motion signal of a motion of a mobile device, wherein the first motion signal is generated by remotely sensing the motion of the mobile device at a system or device that is separate and remote from the mobile device;
receiving data that includes a second motion signal, wherein the second one motion signal is generated by sensing the motion of the mobile device in-situ at the mobile device;
comparing the first motion signal with the second motion signal; and
verifying, based on a result of the comparison, that a relay attack is not present when the first motion signal is substantially similar to the second motion signal.

20. The non-transitory computer-readable medium of claim 19, wherein the operations further comprise generating an alarm signal when the first motion signal is not substantially similar to the second motion signal.

21. The method according to claim 2, wherein wirelessly locating the mobile device with an array of antennas, comprises:
receiving one or more wireless signals from the mobile device at the array of antennas; and
wirelessly locating the mobile device based on a timing, angle, or power of the one or more wireless signals with respect to each antenna in the array of antennas.

22. The method according to claim 3, wherein:
processing image signals received from one or more cameras comprises processing image signals received from at least two cameras fixed at known positions;
remotely sensing the motion of the mobile device further comprises capturing, by each of the at least two cameras, multiple images of the mobile device as the mobile device moves through space according to the motion of the mobile device; and
processing image signals received from one or more cameras further comprises:
identifying the mobile device or one or more feature points of the mobile device in each of the multiple images;
identifying relative positions and locations of the mobile device or the one or more feature points of the mobile device in the multiple images; and
triangulating the motion of the mobile device based on the identified relative positions and locations.

23. The method according to claim 1, wherein remotely sensing the motion of the mobile device comprises:
measuring a time it takes light to travel to the mobile device and return to a time-of-flight depth camera; and
determining a path length the light travels from the time it takes the light to travel to the mobile device and return to the time-of-flight depth camera.

24. The method according to claim 1, wherein remotely sensing the motion of the mobile device comprises processing a light pattern reflected by the mobile device and a scene around the mobile device.
